(19) United States
(12) Patent Application Publication
(10) Pub. No.: US 2025/0063316 A1
(43) Pub. Date: Feb. 20, 2025

(54) SIGNAL PROCESSING APPROXIMATING A STANDARDIZED STUDIO EXPERIENCE IN A VEHICLE AUDIO SYSTEM HAVING NON-STANDARD SPEAKER LOCATIONS

(71) Applicant: Atieva, Inc., Newark, CA (US)

(72) Inventors: Antonios Karalis, Palo Alto, CA (US); Peter J. Andrews, Hayward, CA (US); Arvind Agrawal, San Jose, CA (US)

(21) Appl. No.: 18/720,173

(22) PCT Filed: Dec. 14, 2022
(86) PCT No.: PCT/US2022/081582

§ 371 Date: Jun. 14, 2024

Related U.S. Application Data
(60) Provisional application No. 63/265,446, filed on Dec. 15, 2021.

(51) Int. Cl. H04S 7/00; H04R 3/12; H04R 5/02

(52) U.S. Cl. CPC H04S 7/301; H04R 3/12; H04R 5/02; H04R 2499/13

(57) ABSTRACT

A method of approximating a standardized studio experience when rendering surround sound signals in a vehicle having non-standard speaker locations comprises: receiving, by an audio system of a vehicle, surround-sound signals that also include a height dimension, the surround sound signals including first channels configured according to standardized speaker locations, wherein speaker positions of the audio system do not correspond to the standardized speaker locations; performing, using the audio system, sum and difference signal processing on respective pairs of the channels around the vehicle, the sum and difference signal processing based on the speaker positions of the audio system; and rendering, using the audio system, audio in the speakers of the vehicle based on the sum and difference signal processing of the surround-sound signals.

### CROSS-REFERENCE TO RELATED APPLICATION

This application claims priority to U.S. Patent Application No. 63/265,446, filed on Dec. 15, 2021, and entitled “SIGNAL PROCESSING APPROXIMATING A STANDARDIZED STUDIO EXPERIENCE IN A VEHICLE AUDIO SYSTEM HAVING NON-STANDARD SPEAKER LOCATIONS,” the disclosure of which is incorporated by reference herein in its entirety.

### TECHNICAL FIELD

This disclosure relates to performing signal processing in a vehicle audio system having non-standard speaker locations.

### BACKGROUND

While vehicles have had audio systems for decades, they have generally not been able to provide a listening experience close to the most sophisticated systems used in public venues such as movie theaters or the rapidly developing field of high-end home surround sound systems. However, the advancement and complexification of vehicle technology has changed the playing field in this regard. First, vehicles nowadays are provided with significantly more powerful computer processing resources which can increase the expectations of owners or other passengers of what the experience of riding in a modern vehicle should be like. Second, the proliferation of electric powertrains and advancements in aerodynamic design have made vehicles significantly quieter while driving, which increases the opportunity for the occupant to enjoy a first-class audio performance.

### SUMMARY

In an aspect, a method of approximating a standardized studio experience when rendering surround sound signals in a vehicle having non-standard speaker locations comprises: receiving, by an audio system of a vehicle, surround-sound signals that also include a height dimension, the surround sound signals including first channels configured according to standardized speaker locations, wherein speaker positions of the audio system do not correspond to the standardized speaker locations; performing, using the audio system, sum and difference signal processing on respective pairs of the channels around the vehicle, the sum and difference signal processing based on the speaker positions of the audio system; and rendering, using the audio system, audio in the speakers of the vehicle based on the sum and difference signal processing of the surround-sound signals.

Implementations can include any or all of the following features. The channels comprise lateral channels and upper channels, and wherein the sum and difference signal processing at least in part comprises mixing between a pair of one of the lateral channels and one of the upper channels. The sum and difference signal processing at least in part comprises widening a sound image in a front of the vehicle. The sum and difference signal processing at least in part comprises bringing a channel more around to a side of the vehicle. The sum and difference signal processing at least in part comprises moving rear sound forward in the vehicle. The sum and difference signal processing comprises mixing the first channels into an equal number of second channels. The second channels include seven lateral channels, four upper channels, and four woofer channels. At least one of the pairs comprises a channel and a next channel going rearward in the vehicle. The sum and difference signal processing at least in part comprises not changing a delay of any of the speakers but changing a delay of a signal going to the speaker.

### BRIEF DESCRIPTION OF DRAWINGS

FIG. 1 schematically shows an example of standardized speaker locations for a surround sound, and a vehicle with an audio system having non-standard speaker locations.

FIG. 2 shows an example of a vehicle audio system that can perform sum and difference signal processing to approximating a standardized studio experience.

FIG. 3 illustrates an example architecture of a computer system.

Like reference symbols or numerals in the various drawings indicate like elements.

### DETAILED DESCRIPTION

The present disclosure gives examples of systems and techniques that process surround-sound signals to approximate a standardized studio experience in a vehicle having non-standard speaker locations. The surround-sound signals may have a height dimension that is intended to give an even more immersive sound experience. In some implementations, such surround-sound signals can include so-called DOLBYATMOS signals that conform to, and derive their name from, a coding scheme developed by Dolby Laboratories. For example, a DOLBYATMOS signal characterized by the expression 7.1.4 represents the combination of a conventional eight-channel surround-sound signal (the 7.1 part) with four overhead or upper channels (the .4 part). That is, the surround-sound signals with one or more height dimensions can produce a z dimension (e.g., at a height or ceiling level) in addition to the more common x and y dimensions (e.g., as rendered by 5, 7, 9, 11 or another number of individual speakers) that form the horizontal plane of traditional surround sound. To have a non-standard speaker layout in a vehicle can mean that one or more of its speakers are in positions other than the ones recommended with regard to particular surround-sound rendering. The speaker placement in a vehicle can be influenced by non-audio concerns such as space constraints or other packaging concerns limitations. A vehicle audio system as described herein can perform signal processing to compensate for the non-standard speaker locations so as to give an audio performance that is as close as possible to the immersive audio experience that the surround-sound signals are intended to provide. Such signal processing can involve mixing the surround-sound signals with each other to restore the sense of where the vehicle speakers are supposed to be. Examples include, but are not limited to, making a front audio image in the vehicle wider, or pulling a rear audio image forward in the vehicle. The mixing can be performed pairwise between channels, such as between lateral channels and upper channels to re-spread the audible locations of speaker channels to get back some of the audio image angles that may have been recommended under the particular surround-sound coding scheme.

Examples herein refer to a vehicle. A vehicle is a machine that transports passengers or cargo, or both. A vehicle can have one or more motors using at least one type of fuel or other energy source (e.g., electricity). Examples of vehicles include, but are not limited to, cars, trucks, and buses. The number of wheels can differ between types of vehicles, and one or more (e.g., all) of the wheels can be used for propulsion of the vehicle. The vehicle can include a passenger compartment accommodating one or more persons. At least one vehicle occupant can be considered the driver; various tools, implements, or other devices, can then be provided to the driver. In examples herein, any person carried by a vehicle can be referred to as a “driver” or a “passenger” of the vehicle, regardless whether or to what extent the person is driving the vehicle, or whether the person has access to all or only some of the controls for driving the vehicle, or whether the person lacks controls for driving the vehicle.

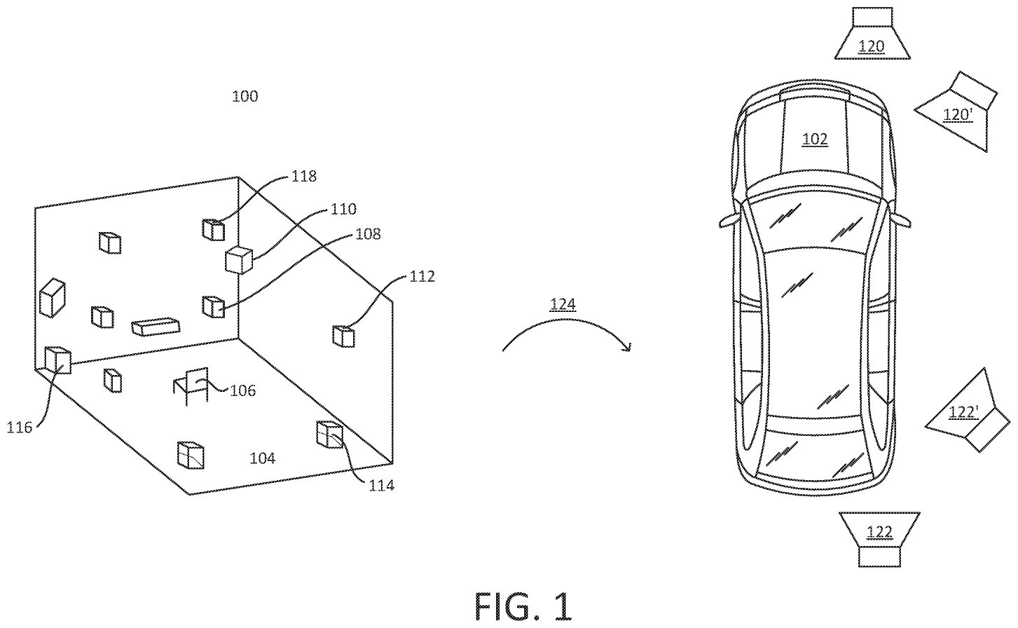

FIG. 1 schematically shows an example of standardized speaker locations 100 for a surround sound coding scheme, and a vehicle 102 with an audio system having non-standard speaker locations. The standardized speaker locations 100 are schematically shown with reference to a space 104 (e.g., a residential room or a movie theater) in which one or more people can listen to audio played by an audio system (e.g., including one or more amplifier coupled to a local or remote audio source). The floor and two walls of the space 104 are shown, whereas a ceiling and one or more additional walls are here omitted for clarity. A chair 106 schematically illustrates an intended location for one or more listeners.

The standardized speaker locations 100 illustrate that speakers intended to perform somewhat or completely different functions from each other can be distributed about the space 104. For example, a speaker 108 can represent at least one front speaker location (e.g., respective left front, center front, and right front locations). As another example, a speaker 110 can represent at least one surround speaker location (e.g., respective left surround, and right surround locations). As another example, a speaker 112 can represent at least one center surround speaker location (e.g., respective left center surround, and right center surround locations). As another example, a speaker 114 can represent at least one rear surround speaker location (e.g., respective left rear surround, and right rear surround locations). As another example, a speaker 116 can represent at least one rear woofer speaker location. As another example, a speaker 118 can represent at least one height speaker location (e.g., respective left height, and right height locations). Other speaker locations can be included in the standardized speaker locations 100 depending on the particular surround-sound coding scheme.

The vehicle 102 is here shown in a top view. The actual speakers (e.g., transducers including, but not limited to, tweeters, midrange speakers, or woofers) are not shown in the illustration but are generally located at various positions inside the vehicle 102. For example, the audio system of the vehicle 102 can be characterized as a 7.3.4 system having seven horizontal channels (e.g., in a shoulder plane about the occupant), three woofers distributed at locations within the vehicle, and four channels in the inside ceiling (sometimes called the roof liner) of the vehicle. By way of characterization, this speaker arrangement can be referred to as a placement within a long narrow cabin of the vehicle 102. By contrast, the speakers that are shown relative to the vehicle 102 in the present illustration are not physical speakers, but rather represent locations of perceived sound sources in a surround-sound experience provided by the vehicle audio system.

Due to the non-standard speaker locations, the audio image provided by the vehicle 102 may be insufficiently immersive unless signal processing is performed as described herein. In some implementations, without the present signal processing, the vehicle audio system may subject the occupant to a perceived audio direction 120. For example, the perceived audio direction 120 can correspond to a front right channel rendered using a speaker in the instrument panel (also known as dashboard) of the vehicle 102, whereas none of the signal is rendered using a door speaker. The perceived audio direction 120 may be considered too narrow (e.g., having too small of an included angle, or not being as wide as may have been intended with the surround-sound coding scheme).

With the present signal processing, by contrast, the vehicle audio system may instead subject the occupant to a perceived audio direction 120′. This can be accomplished by a mixing between a pair of channels: the front right channel mentioned above, and a right rear door channel which may be the next channel rearward as one goes around the vehicle (e.g., this latter channel may be almost directly behind the occupant in this case). To be clear, the front channel may be too far in front of the occupant, and the width (door) channel may be too far behind the occupant, but by performing mixing by way of signal processing and with some delay between them, the audio system can create the impression that the sound is coming more from straight off the shoulder of the occupant. For example, the perceived audio direction 120′ can represent a widening of the audio image in front of the occupant. As another example, the perceived audio direction 120′ can represent bringing the audio image laterally away from the occupant (e.g., toward the right side in the illustration).

In some implementations, without the present signal processing, the vehicle audio system may subject the occupant to a perceived audio direction 122, which may be considered too far back (e.g., not as longitudinally close to the occupant as may have been intended with the surround-sound coding scheme). With the present signal processing, by contrast, the vehicle audio system may instead subject the occupant to a perceived audio direction 122′. For example, the perceived audio direction 122′ can represent moving rear sound of the audio image more forward toward the occupant.

In short, the present signal processing can mix channels together to move an apparent location further out relative to the occupant and/or to a different angle relative to the occupant. An arrow 124 between the standardized speaker locations 100 and the vehicle 102 conceptually indicates that signal processing is performed on surround-sound signals to approximate a standardized studio experience using the non-standard speaker locations of the vehicle 102.

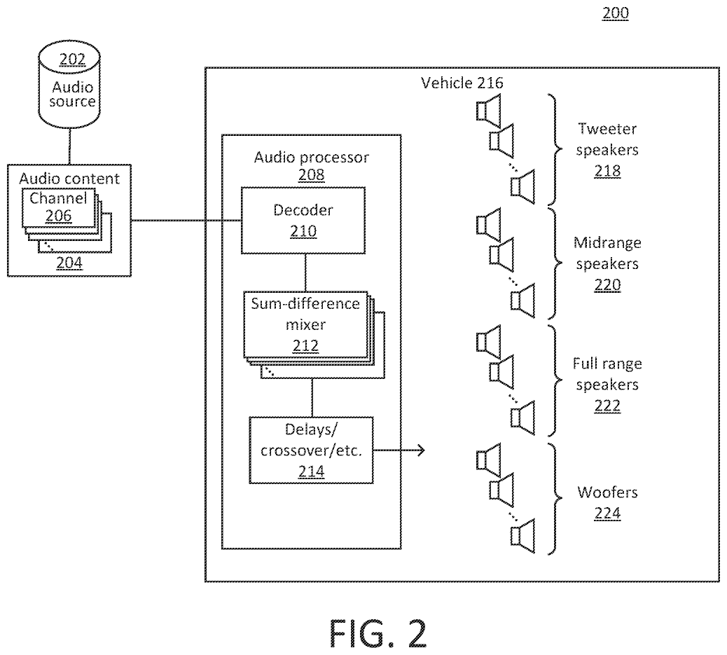

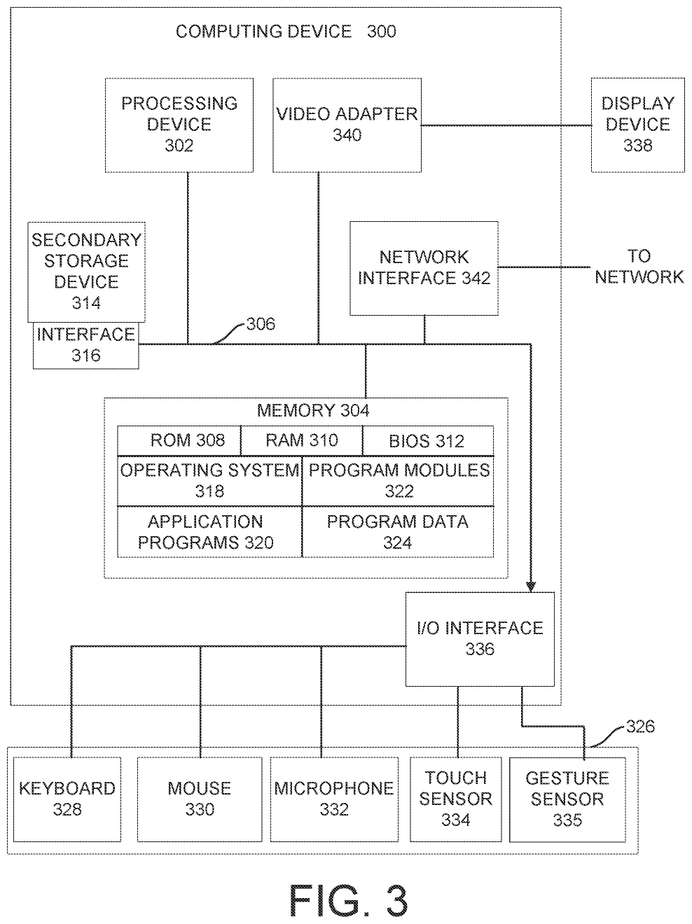

FIG. 2 shows an example of a vehicle audio system 200 that can perform sum and difference signal processing to approximating a standardized studio experience. The vehicle audio system 200 can be used with one or more other examples described elsewhere herein. The vehicle audio system 200 can be implemented using some or all examples described below with reference to FIG. 3.

The vehicle audio system 200 includes at least one audio source 202. The audio source 202 can be local to the vehicle (e.g., a local hard drive, memory, or other audio storage device), or can be remote (e.g., a network connection to one or more remotely located servers that supply audio content in one or more coding formats). Here, audio content 204 from the audio source 202 is schematically shown as including channels 206 of audio information. For example, when the surround-sound signal includes seven lateral channels, four height channels, and one woofer channel, there can be twelve of the channels 206. Any other number of channels can be used.

The vehicle audio system 200 can include an audio processor 208 that can receive or obtain from the audio source 202 the audio content 204 having the channels 206. The audio processor 208 includes at least one decoder 210 for the audio content 204. The decoder 210 can be specific to the audio coding scheme of the surround-sound signals. For example, when the surround-sound signals are DOLBYATMOS signals, the decoder 210 can be a DOLBY ATMOS decoder.

The audio processor 208 includes sum-difference mixers 212 that perform signal processing on the surround-sound signals to compensate for the non-standard speaker locations. In some implementations, sum and difference signal processing includes frequency-dependent mixing that is performed between pairs of channels as one goes around the vehicle. The sum and difference signal processing can be based on what is the same (e.g., what is mono) between two channels (including, but not limited to, two stereo channels) by adding them together in a certain way, and also what is different about the signals (e.g., what is stereo between the channels).

In some implementations, a sum signal M can be obtained as

$$M = \frac{{C}_{A} + {C}_{B}}{2} ,$$

where C_{A} and C_{B} are the respective signal components for the two channels. Similarly, a difference signal S can be obtained as

$$S = \frac{{C}_{A} - {C}_{B}}{2} .$$

That is, the sum and difference signal processing is a multidimensional mixing, and when the audio system mixes back in the sum/difference signals, they can not only be mixed at relative levels, but they can be mixed at relative delays. This can create a sense of either more space (e.g., being wider) or less space (e.g., being narrower) depending on what is done with both the levels and the delays.

The mixing by way of sum and difference signal processing (e.g., using M and S above) can facilitate modification (e.g., exaggeration) of spatial effects, such as when the audio system is confined to a relatively small physical cabinet. For example, the sum and difference signal processing can allow the audio system engineer to effectively dial in a spatial feeling for the two channels at issue and mix that in individually into each one.

In some implementations, the signal processing as described herein can be configured using a graphical programming language. For example, diagrams can be provided that define the cross-channel mixing that is being performed throughout the vehicle. Such a diagram can in a sense indicate where the channels of the surround-sound signals are supposed to be according to the standardized speaker locations; where the channels are in the vehicle; and how the signal processing compensates for the differences between the two.

A delay can be used in some signal processing described herein, as has been mentioned in examples. For example, in sum and difference signal processing (e.g., taking into account the mono/stereo information), using a delay can create a sense of wider stereo, or conversely if mixing more toward the mono with no delay such as to collapse the two channels into an area in between.

The delay mentioned just above is not the same as the delay between two or more channels that can be introduced during calibration of the audio system. Such calibration can be done earlier (e.g., before the signal processing as described herein is defined) and can remain essentially unchanged regardless of the particular mixing performed pairwise between different channels according to the present disclosure. In some implementations, an automated calibration can be performed that seeks to ensure that signals rendered by various speakers will arrive at an occupant's ears at essentially the same time. Here an operation 214 is shown as being performed after the signal processing by the sum-difference mixers 212. For example, the operation 214 can introduce one or more delays and/or apply a crossover circuitry or other filtering. This can be characterized in that the present sum and difference signal processing can include, not changing a delay of any of the speakers, but changing a delay of a signal going to the speaker.

At least the audio processor 208 can be implemented in a vehicle 216, as schematically indicated. The vehicle 216 includes speakers in a non-standard layout. After the operation 214 (e.g., immediately subsequent to, or further downstream), audio is rendered using some or all of the speakers.

One or more types of speaker types can be used, including, but not limited to, tweeter speakers, midrange speakers, full range speakers, and/or woofers. Each speaker (type) can include one or more transducers (e.g., a voice coil) for converting an electric input to sound waves. The vehicle 216 can include n number of tweeter speakers 218 that can have any of multiple arrangements within the vehicle 216. In some implementations, seven of the tweeter speakers 218 are used. The vehicle 216 can include m number of midrange speakers 220 that can have any of multiple arrangements within the vehicle 216. In some implementations, seven of the midrange speakers 220 are used. The vehicle 216 can include p number of full range speakers 222 (sometimes referred to as twiddler speakers) that can have any of multiple arrangements within the vehicle 216. In some implementations, four of the full range speakers 222 are used (e.g., at the height position). The vehicle 216 can include q number of woofers 224 (e.g., subwoofers) that can have any of multiple arrangements within the vehicle 216. In some implementations, three of the woofers 224 are used (e.g., one in each of the A-pillars of the vehicle, and one in the trunk).

FIG. 3 illustrates an example architecture of a computing device 300 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 3 can be used to execute the operating system, application programs, and/or software modules (including the software engines) described herein.

The computing device 300 includes, in some embodiments, at least one processing device 302 (e.g., a processor), such as a central processing unit (CPU). A variety of processing devices are available from a variety of manufacturers, for example, Intel or Advanced Micro Devices. In this example, the computing device 300 also includes a system memory 304, and a system bus 306 that couples various system components including the system memory 304 to the processing device 302. The system bus 306 is one of any number of types of bus structures that can be used, including, but not limited to, a memory bus, or memory controller; a peripheral bus; and a local bus using any of a variety of bus architectures.

Examples of computing devices that can be implemented using the computing device 300 include a desktop computer, a laptop computer, a tablet computer, a mobile computing device (such as a smart phone, a touchpad mobile digital device, or other mobile devices), or other devices configured to process digital instructions.

The system memory 304 includes read only memory 308 and random access memory 310. A basic input/output system 312 containing the basic routines that act to transfer information within computing device 300, such as during start up, can be stored in the read only memory 308.

The computing device 300 also includes a secondary storage device 314 in some embodiments, such as a hard disk drive, for storing digital data. The secondary storage device 314 is connected to the system bus 306 by a secondary storage interface 316. The secondary storage device 314 and its associated computer readable media provide nonvolatile and non-transitory storage of computer readable instructions (including application programs and program modules), data structures, and other data for the computing device 300.

Although the example environment described herein employs a hard disk drive as a secondary storage device, other types of computer readable storage media are used in other embodiments. Examples of these other types of computer readable storage media include magnetic cassettes, flash memory cards, solid-state drives (SSD), digital video disks, Bernoulli cartridges, compact disc read only memories, digital versatile disk read only memories, random access memories, or read only memories. Some embodiments include non-transitory media. For example, a computer program product can be tangibly embodied in a non-transitory storage medium. Additionally, such computer readable storage media can include local storage or cloud-based storage.

A number of program modules can be stored in secondary storage device 314 and/or system memory 304, including an operating system 318, one or more application programs 320, other program modules 322 (such as the software engines described herein), and program data 324. The computing device 300 can utilize any suitable operating system.

In some embodiments, a user provides inputs to the computing device 300 through one or more input devices 326. Examples of input devices 326 include a keyboard 328, mouse 330, microphone 332 (e.g., for voice and/or other audio input), touch sensor 334 (such as a touchpad or touch sensitive display), and gesture sensor 335 (e.g., for gestural input). In some implementations, the input device(s) 326 provide detection based on presence, proximity, and/or motion. Other embodiments include other input devices 326. The input devices can be connected to the processing device 302 through an input/output interface 336 that is coupled to the system bus 306. These input devices 326 can be connected by any number of input/output interfaces, such as a parallel port, serial port, game port, or a universal serial bus. Wireless communication between input devices 326 and the input/output interface 336 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 338, such as a monitor, liquid crystal display device, light-emitting diode display device, projector, or touch sensitive display device, is also connected to the system bus 306 via an interface, such as a video adapter 340. In addition to the display device 338, the computing device 300 can include various other peripheral devices (not shown), such as speakers or a printer.

The computing device 300 can be connected to one or more networks through a network interface 342. The network interface 342 can provide for wired and/or wireless communication. In some implementations, the network interface 342 can include one or more antennas for transmitting and/or receiving wireless signals. When used in a local area networking environment or a wide area networking environment (such as the Internet), the network interface 342 can include an Ethernet interface. Other possible embodiments use other communication devices. For example, some embodiments of the computing device 300 include a modem for communicating across the network.

The computing device 300 can include at least some form of computer readable media. Computer readable media includes any available media that can be accessed by the computing device 300. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 300.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 3 is also an example of programmable electronics, which may include one or more such computing devices, and when multiple computing devices are included, such computing devices can be coupled together with a suitable data communication network so as to collectively perform the various functions, methods, or operations disclosed herein.

In some implementations, the computing device 300 can be characterized as an ADAS computer. For example, the computing device 300 can include one or more components sometimes used for processing tasks that occur in the field of artificial intelligence (AI). The computing device 300 then includes sufficient proceeding power and necessary support architecture for the demands of ADAS or AI in general. For example, the processing device 302 can include a multicore architecture. As another example, the computing device 300 can include one or more co-processors in addition to, or as part of, the processing device 302. In some implementations, at least one hardware accelerator can be coupled to the system bus 306. For example, a graphics processing unit can be used. In some implementations, the computing device 300 can implement a neural network-specific hardware to handle one or more ADAS tasks.

The terms “substantially” and “about” used throughout this Specification are used to describe and account for small fluctuations, such as due to variations in processing. For example, they can refer to less than or equal to ±5%, such as less than or equal to ±2%, such as less than or equal to ±1%, such as less than or equal to ±0.5%, such as less than or equal to ±0.2%, such as less than or equal to ±0.1%, such as less than or equal to ±0.05%. Also, when used herein, an indefinite article such as “a” or “an” means “at least one.”

It should be appreciated that all combinations of the foregoing concepts and additional concepts discussed in greater detail below (provided such concepts are not mutually inconsistent) are contemplated as being part of the inventive subject matter disclosed herein. In particular, all combinations of claimed subject matter appearing at the end of this disclosure are contemplated as being part of the inventive subject matter disclosed herein.

A number of implementations have been described. Nevertheless, it will be understood that various modifications may be made without departing from the spirit and scope of the specification.

In addition, the logic flows depicted in the figures do not require the particular order shown, or sequential order, to achieve desirable results. In addition, other processes may be provided, or processes may be eliminated, from the described flows, and other components may be added to, or removed from, the described systems. Accordingly, other implementations are within the scope of the following claims.

While certain features of the described implementations have been illustrated as described herein, many modifications, substitutions, changes and equivalents will now occur to those skilled in the art. It is, therefore, to be understood that appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein can include various combinations and/or sub-combinations of the functions, components and/or features of the different implementations described.

What is claimed is:

1. A method of approximating a standardized studio experience when rendering surround sound signals in a vehicle having non-standard speaker locations, the method comprising:
receiving, by an audio system of a vehicle, surround sound signals that also include a height dimension, the surround sound signals including first channels configured according to standardized speaker locations, wherein speaker positions of the audio system do not correspond to the standardized speaker locations;
performing, using the audio system, sum and difference signal processing on respective pairs of the first channels around the vehicle, the sum and difference signal processing based on the speaker positions of the audio system; and
rendering, using the audio system, audio in the speakers of the vehicle based on the sum and difference signal processing of the surround-sound signals.

2. The method of claim 1, wherein the first channels comprise lateral channels and upper channels, and wherein the sum and difference signal processing at least in part comprises mixing between a pair of one of the lateral channels and one of the upper channels.

3. The method of claim 1, wherein the sum and difference signal processing at least in part comprises widening a sound image in a front of the vehicle.

4. The method of claim 1, wherein the sum and difference signal processing at least in part comprises bringing at least one of the first channels more around to a side of the vehicle.

5. The method of claim 1, wherein the sum and difference signal processing at least in part comprises moving rear sound forward in the vehicle.

6. The method of claim 1, wherein the sum and difference signal processing comprises mixing the first channels into an equal number of second channels.

7. The method of claim 6, wherein the second channels include seven lateral channels, four upper channels, and four woofer channels.

8. The method of claim 1, wherein at least one of the pairs comprises one of the first channels and a next channel of the first channels going rearward in the vehicle.

9. The method of claim 1, wherein the sum and difference signal processing at least in part comprises not changing a delay of any of the speakers but changing a delay of a signal going to the speaker.
